(19) United States
(12) Patent Application Publication
(10) Pub. No.: US 2026/0079813 A1
(43) Pub. Date: Mar. 19, 2026

(54) PRODUCING A SIMULATION RECORDING TO TEST AN AUTOMATED DRIVING SYSTEM

(71) Applicant: Toyota Motor Engineering & Manufacturing North America, Inc., Plano, TX (US)

(72) Inventors: Yan Miao, Champaign, IL (US); Bardh Hoxha, Canton, MI (US); Georgios Fainekos, Novi, MI (US); Hideki Okamoto, Ann Arbor, MI (US); Miles J. Johnson, Ann Arbor, MI (US); Vladimeros Vladimerou, Whitmore Lake, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/016,308

(22) Filed: Jan. 10, 2025

Related U.S. Application Data
(60) Provisional application No. 63/695,599, filed on Sep. 17, 2024.

(51) Int. Cl. G06F 11/34; G06F 11/3668; H04N 21/266

(52) U.S. Cl. CPC G06F 11/3457; G06F 11/3684; H04N 21/26603

(57) ABSTRACT

A system for producing a simulation recording to test an automated driving system can include a processor, a communications device, and a memory. The memory can store a comparison module, a feedback module, and a communications module. The comparison module can determine a similarity between a feature vector associated with a first prospective video and a feature vector with a real video. The feedback module can cause, in response to the similarity being less than a threshold, feedback to be sent to a video language model to be used to convert the real video into a textual description to produce a second prospective recording. The communications module can cause, in response to the similarity being greater than the threshold, the first prospective recording to be communicated, via the communications device, to a device to test the automated driving system.

### CROSS-RELATED TO RELATED APPLICATIONS

This application claims the benefit of U.S. Provisional Application No. 63/695,599, filed Sep. 17, 2024, which is incorporated herein in its entirety by reference.

### TECHNICAL FIELD

The disclosed technologies are directed to producing a simulation recording to test an automated driving system.

### BACKGROUND

Because a motorized vehicle can weigh significantly more than a human being and can move at high speeds, a collision that involves the motorized vehicle can cause damage to an object involved in the collision, injury to a living being involved in the collision, or both. For at least this reason, it can be useful to use a driving simulator to train an operator of a motorized vehicle. Typically, a driving simulator can include a processor, a display, and one or more car controls (e.g., a steering control device, an acceleration control device, a deceleration control device (e.g., a brake control device), a transmission control device, etc.). For example, the driving simulator can cause a driving scenario to be presented on the display and a user of the driving simulator can operate the car controls in response to the driving scenario. For example, the driving simulator can be configured to produce a recording of operations of the car controls by the user during a presentation of the driving scenario. Information in the recording can be used to train the user to operate a motorized vehicle.

Some operations of a motorized vehicle can be automated using an automated driving system. The automated driving system can include artificial intelligence (AI) technology and a perception system. Automation of control of some operations can reduce problems caused by miscalculations made when such operations are controlled by a human being. The perception system can provide the motorized vehicle with an ability to perceive objects in an environment of the motorized vehicle. The perception system can depend upon data produced by sensors disposed on the motorized vehicle. Such sensors can include, for example, one or more imaging devices. The AI technology can be trained to control some operations of the motorized vehicle based on information obtained from the perception system. Because the AI technology is trained to control such operations based on the information obtained from the perception system, a driving simulator can also be useful to train the automated driving system.

### SUMMARY

In an embodiment, a system for producing a simulation recording to test an automated driving system can include a processor, a communications device, and a memory. The memory can store a comparison module, a feedback module, and a communications module. The comparison module can include instructions that, when executed by the processor, cause the processor to determine a similarity between a feature vector associated with a first prospective recording and a feature vector associated with a real video. The feedback module can include instructions that, when executed by the processor, cause the processor to cause, in response to the similarity being less than a threshold, feedback to be sent to a video language model to be used to convert the real video into a textual description to produce a second prospective recording. The communications module can include instructions that, when executed by the processor, cause the processor to cause, in response to the similarity being greater than the threshold, the first prospective recording to be communicated, via the communications device, to a device to test the automated driving system.

In another embodiment, a method for producing a simulation recording to test an automated driving system can include determining, by a processor, a similarity between a feature vector associated with a first prospective recording and a feature vector associated with a real video. The method can include causing, by the processor and in response to the similarity being less than a threshold, feedback to be sent to a video language model to be used to convert the real video into a textual description to produce a second prospective recording. The method can include causing, by the processor and in response to the similarity being greater than the threshold, the first prospective recording to be communicated to a device to test the automated driving system.

In another embodiment, a non-transitory computer-readable medium for producing a simulation recording to test an automated driving system can include instructions that, when executed by one or more processors, cause the one or more processors to determine a similarity between a feature vector associated with a first prospective recording and a feature vector associated with a real video. The non-transitory computer-readable medium can include instructions that, when executed by one or more processors, cause the one or more processors to cause, in response to the similarity being less than a threshold, feedback to be sent to a video language model to be used to convert the real video into a textual description to produce a second prospective recording. The non-transitory computer-readable medium can include instructions that, when executed by one or more processors, cause the one or more processors to cause, in response to the similarity being greater than the threshold, the first prospective recording to be communicated to a device to test the automated driving system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a block diagram that illustrates an example of an environment for testing an automated driving system, according to the disclosed technologies.

FIG. 2 includes a block diagram that illustrates an example of an iteration of a system for producing a simulation recording to test the automated driving system, according to the disclosed technologies.

FIG. 3 includes a diagram that illustrates a table of examples of features and thresholds, according to the disclosed technologies.

FIG. 4 includes a flow diagram that illustrates an example of a method that is associated with producing a simulation recording to test an automated driving system, according to the disclosed technologies.

### DETAILED DESCRIPTION

The disclosed technologies are directed to producing a simulation video to test an automated driving system (e.g., an advanced driver-assistance system (ADAS)). The automated driving system can automate some operations of a motorized vehicle. Because the motorized vehicle can weigh significantly more than a human being and can move at high speeds, a collision that involves the motorized vehicle can cause damage to an object involved in the collision, injury to a living being involved in the collision, or both. For at least this reason it can be desirable to train the automated driving system to control the operations of the motorized vehicle in a manner that avoids the collision or mitigates an effect of the collision. For example, the automated driving system can be tested using one or more simulation recordings of one or more collisions. For example, the one or more simulation recordings can be produced from one or more real videos of the one or more collisions. For example, by testing the automated driving system using a plurality of simulation recordings produced from a plurality of real videos of a plurality of collisions, the automated driving system can be tested with respect to a wide variety of collision scenarios.

For example, a real video, of the one or more real videos, can include a video of a collision produced by a dashboard camera of a motorized vehicle that was involved in the collision. For example, the real video can be from the Car Crash Dataset compiled by the Massachusetts Institute of Technology. Because a format of the one or more real videos may be incompatible with a device to test the automated driving system, the one or more real videos may include information that distracts from a performance of a test of the automated driving system, or both, the disclosed technologies are directed to producing a simulation recording from a real video so that the simulation recording can be compatible with the device to test the automated driving system, the simulation recording can exclude the information that distracts from the performance of the test of the automated driving system, or both.

A similarity between: (1) a feature vector associated with a first prospective recording and (2) a feature vector associated with a real video can be determined. For example, a feature can include information about weather, road layouts, road types, road conditions, driving scenarios, traffic behavior, vehicle dynamics, vehicle behavior, environmental factors, or the like. For example, the driving scenarios can include overtaking, cruising, sudden stops due to obstacles, turns in varying road conditions, turns in varying weather conditions, or the like. For example, the feature can include information to distinguish whether the weather is sunny or rainy, the road is in an urban setting or on a highway, a random object exists on the road, a leading vehicle is cruising, the leading vehicle is stopped, a parallel vehicle is cutting in, the parallel vehicle is cruising, the parallel vehicle is stopped, a behind vehicle is overtaking, an opposite vehicle is turning, or the like. Additionally, for example, the feature can include any quantitative spatio-temporal evaluation metric, an output from a machine-learning model that compares two image-related files for specific features, Boolean features (e.g., whether the two image-related files satisfy a Spatial Regular Expression query as described in U.S. application Ser. No. 18/471,829, filed Sep. 21, 2023, which is incorporated herein in its entirety by reference), or the like. In response to the similarity being less than a threshold, feedback to be sent to a video language model to be used to convert the real video into a textual description to produce a second prospective recording. With this approach, for example, a quality of prospective recordings, with respect to features to be included in the simulation recording, can be improved in an iterative manner. In response to the similarity being greater than the threshold, the first prospective recording can be communicated to the device to test the automated driving system. For example, in response to the similarity being greater than the threshold, the first prospective recording can be the simulation recording.

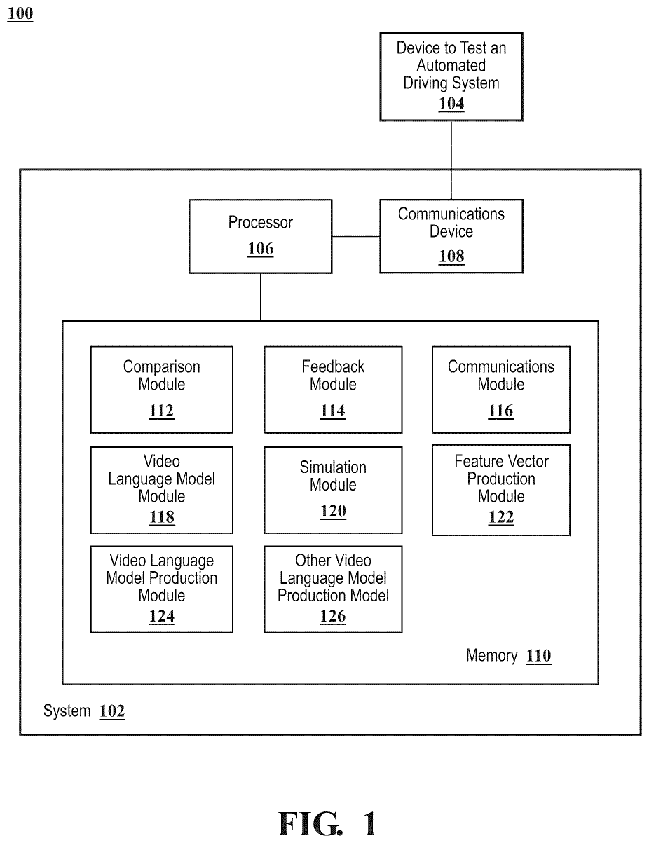

FIG. 1 includes a block diagram that illustrates an example of an environment 100 for testing an automated driving system, according to the disclosed technologies. The environment 100 can include, for example: (1) a system 102 for producing a simulation recording to test the automated driving system and (2) a device 104 to test the automated driving system. The system 102 can include, for example, a processor 106, a communications device 108, and a memory 110. The communications device 108 can be communicably coupled to the processor 106. The memory 110 can be communicably coupled to the processor 106. For example, the memory 110 can store a comparison module 112, a feedback module 114, and a communications module 116.

For example, the comparison module 112 can include instructions that function to control the processor 106 to determine a similarity between: (1) a feature vector associated with a first prospective recording and (2) a feature vector associated with a real video.

For example, the feedback module 114 can include instructions that function to control the processor 106 to cause, in response to the similarity being less than a threshold, feedback to be sent to a video language model to be used to convert the real video into a textual description to produce a second prospective recording.

For example, the communications module 116 can include instructions that function to control the processor 106 to cause, in response to the similarity being greater than the threshold, the first prospective recording to be communicated, via the communications device 108, to the device 104 to test the automated driving system.

Additionally, for example, the memory 110 can further store a video language model module 118. For example, the video language model module 118 can include instructions that function to control the processor 106 to cause the real video to be converted, by the video language model, into a textual description to produce the first prospective recording. For example, the textual description to produce the first prospective recording can be prepared using a probabilistic programming language. For example, the probabilistic programming language can be associated with producing scenarios of an environment of a mobile robot (e.g., an automated vehicle) to test the mobile robot. For example, the probabilistic programming language can be SCENIC developed by the University of California, Berkeley.

Additionally, for example, the memory 110 can further store a simulation module 120. For example, the simulation module 120 can include instructions that function to control the processor 106 to produce, using the textual description, the first prospective recording. For example, the instructions to produce the first prospective recording can include instructions to produce, using an autonomous driving simulator, the first prospective recording. For example, the autonomous driving simulator can be CARLA developed by the Computer Vision Center at the Universitat Autonoma de Barcelona.

Additionally, for example, the memory 110 can further store a feature vector production module 122. For example, the feature vector production module 122 can include instructions that function to control the processor 106 to: (1) produce the feature vector associated with the first prospective recording and (2) produce the feature vector associated with the real video. For example: (1) the instructions to produce the feature vector associated with the first prospective recording can include instructions to produce, using a first other video language model, the feature vector associated with the first prospective recording and (2) the instructions to produce the feature vector associated with the real video can include instructions to produce, using a second other video language model, the feature vector associated with the real video. For example, the second other video language model can be identical to the first other video language model.

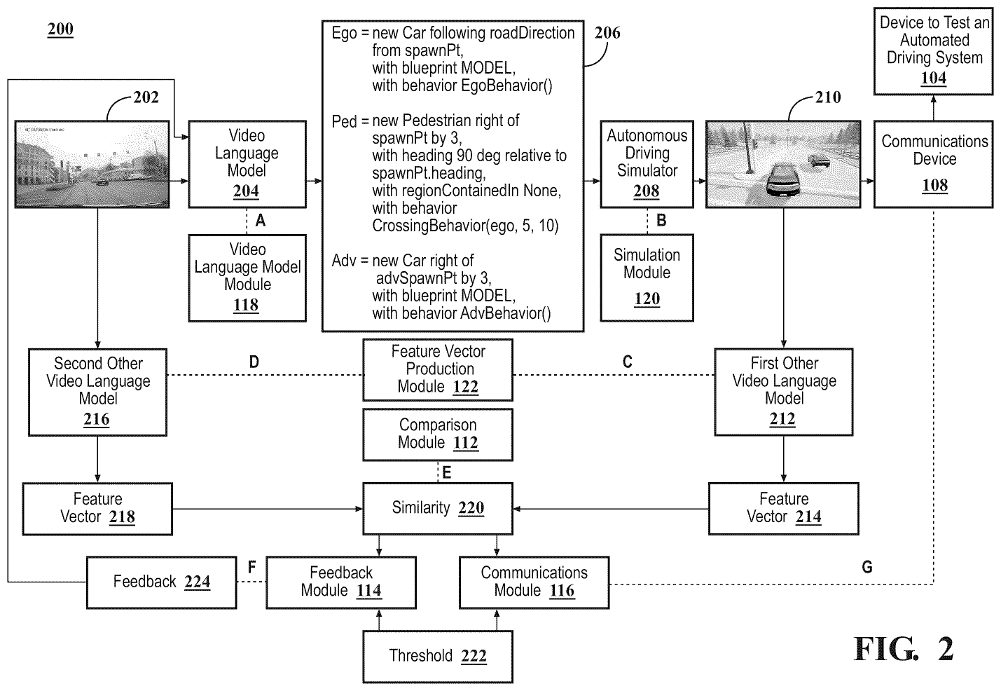

FIG. 2 includes a block diagram that illustrates an example of an iteration 200 of the system 102 for producing the simulation recording to test the automated driving system, according to the disclosed technologies. For example, in the iteration 200: (1) the video language model module 118 can be executed to cause (A) the real video 202 to be converted, by the video language model 204, into the textual description 206, (2) the simulation module 120 can be executed to produce (B), using the textual description 206 and the autonomous driving simulator 208, the first prospective recording 210, (3) the feature vector production module 122 can be executed to produce (C), using the first other video language model 212, the feature vector 214 associated with the first prospective recording 210, (4) the feature vector production module 122 can be executed to produce (D), using the second other video language model 216, the feature vector 218 associated with the real video 202, (5) the comparison module 112 can be executed to determine (E) the similarity 220 between the feature vector 214 and the feature vector 218, (6) the feedback module 114 can be executed to cause (F), in response to the similarity 220 being less than the threshold 222, feedback 224 to be sent to the video language model 204 to be used to convert the real video 202 into a textual description to produce a second prospective recording, and (7) the communications module 116 can be executed to cause (G), in response to the similarity 220 being greater than the threshold 222, the first prospective recording 210 to be communicated, via the communications device 108, to the device 104 to test the automated driving system.

For example, the video language model 204 can include a multimodal generative pre-trained transformer. For example, the multimodal generative pre-trained transformer can include GPT-4o released in May 2024 by OpenAI, Inc. of San Francisco, California.

Returning to FIG. 1, additionally, for example, the memory 110 can further store a video language model production module 124. For example, the video language model production module 124 can include instructions that function to control the processor 106 to produce the video language model. For example, the instructions to produce the video language model can include instructions to produce, using a prompt engineering process, the video language model. For example, a prompt engineering process can be a technique for designing inputs, or prompts, to guide an artificial intelligence (AI) model to generate a specific output. For example, the prompt engineering process can include: (1) preparing, using a probabilistic programming language, a set of training textual descriptions for driving scenarios, (2) producing, from the set of training textual descriptions and using an autonomous driving simulator, a set of training simulation videos, (3) defining a set of pairs, wherein a pair, of the set of pairs, comprises a training simulation video (of the set of training simulation videos) and a corresponding training textual description (of the set of training textual descriptions), and (4) training, using the set of pairs, a pre-prompt engineering version of the video language model to become the video language model. For example, the set of pairs can include twenty pairs. For example, the probabilistic programming language can be associated with producing scenarios of an environment of a mobile robot (e.g., an automated vehicle) to test the mobile robot. For example, the probabilistic programming language can be SCENIC developed by the University of California, Berkeley. For example, the autonomous driving simulator can be CARLA developed by the Computer Vision Center at the Universitat Autonoma de Barcelona. For example, the pre-prompt engineering version of the video language model can be capable of producing textual descriptions that include information about road layouts, traffic behavior, and environmental factors. For example, the set of training textual descriptions can include textual descriptions of a variety of driving scenarios: overtaking, cruising, sudden stops due to obstacles, turns in varying road conditions, and turns in varying weather conditions. For example, the video language model, produced using the prompt engineering process, can be capable of producing textual descriptions that include information about weather, traffic, road types, road conditions, vehicle dynamics, and vehicle behaviors.

Returning to FIG. 2, one or more of the first other video language model 212 or the second other video language model 216 can include a multimodal generative pre-trained transformer. For example, the multimodal generative pre-trained transformer can include GPT-4o released in May 2024 by OpenAI, Inc. of San Francisco, California.

Returning to FIG. 1, additionally, for example, the memory 110 can further store another video language model production module 126. For example, the other video language model production module 126 can include instructions that function to control the processor 106 to produce the one or more of the first other video language model or the second other video language model. For example, the instructions to produce the one or more of the first other video language model or the second other video language model can include instructions to produce, using a prompt engineering process, the one or more of the first other video language model or the second other video language model. For example, a prompt engineering process can be a technique for designing inputs, or prompts, to guide an artificial intelligence (AI) model to generate a specific output. For example, the prompt engineering process can include: (1) predefining a set of feature categories, (2) preparing, using a probabilistic programming language, a set of training textual descriptions for driving scenarios, (3) defining a set of pairs in which a pair (of the set of pairs) can include a training textual description (of the set of training textual descriptions) and a corresponding feature vector (of a set of feature vectors), and (4) training, using the set of pairs, one or more of a pre-prompt engineering version of the first other video language model or a pre-prompt engineering version of the second other video language model to become the one or more of the first other video language model or the second other video language model. For example, a first number can be a count of feature categories in the set of feature categories. For example, the first number can be ten. For example, a second number can be a count of training textual descriptions in the set of training textual descriptions. For example, the second number can be twenty. So, for example: (1) the second number can be a count of feature vectors of the set of feature vectors and (2) the first number can be a count of dimensions in the corresponding feature vector. For example, a dimension (of the dimensions) can be associated with a corresponding feature category (of the set of feature categories). For example, a value of the dimension can be one of a first value (e.g., one) or a second value (e.g., zero). For example, the first value can be indicative of a presence, in the training textual description, of a feature associated with the corresponding feature vector. For example, the second value can be indicative of an absence, in the training textual description, of the feature associated with the corresponding feature vector. For example, the probabilistic programming language can be associated with producing scenarios of an environment of a mobile robot (e.g., an automated vehicle) to test the mobile robot. For example, the probabilistic programming language can be SCENIC developed by the University of California, Berkeley.

For example, the feature vector associated with the first prospective recording can include: (1) information associated with a first feature in the first prospective recording and (2) information associated with a second feature in the first prospective recording. For example, the feature vector associated with the real video can include: (1) information associated with the first feature in the real video and (2) information associated with the second feature in the real video. For example, the similarity can include: (1) a first similarity between the information associated with the first feature in the first prospective recording and the information associated with the first feature in the real video and (2) a second similarity between the information associated with the second feature in the first prospective recording and the information associated with the second feature in the real video.

For example, the instructions to cause, in response to the similarity being less than the threshold, the feedback to be sent to the video language model to be used to convert the real video into the textual description to produce the second prospective recording can include instructions to cause, in response to the first similarity being less than the threshold or the second similarity being less than the threshold, the feedback to be sent to the video language model to be used to convert the real video into the textual description to produce the second prospective recording. For example, the instructions to cause, in response to the similarity being greater than the threshold, the first prospective recording to be communicated, via the communications device, to the device to test the automated driving system can include instructions to cause, in response to the first similarity being greater than the threshold and the second similarity being greater than the threshold, the first prospective recording to be communicated, via the communications device, to the device to test the automated driving system.

Additionally, for example, the threshold can include a first threshold and a second threshold. For example, the instructions to cause, in response to the similarity being less than the threshold, the feedback to be sent to the video language model to be used to convert the real video into the textual description to produce the second prospective recording can include instructions to cause, in response to the first similarity being less than the first threshold or the second similarity being less than the second threshold, the feedback to be sent to the video language model to be used to convert the real video into the textual description to produce the second prospective recording. For example, the instructions to cause, in response to the similarity being greater than the threshold, the first prospective recording to be communicated, via the communications device, to the device to test the automated driving system can include instructions to cause, in response to the first similarity being greater than the first threshold and the second similarity being greater than the second threshold, the first prospective recording to be communicated, via the communications device, to the device to test the automated driving system.

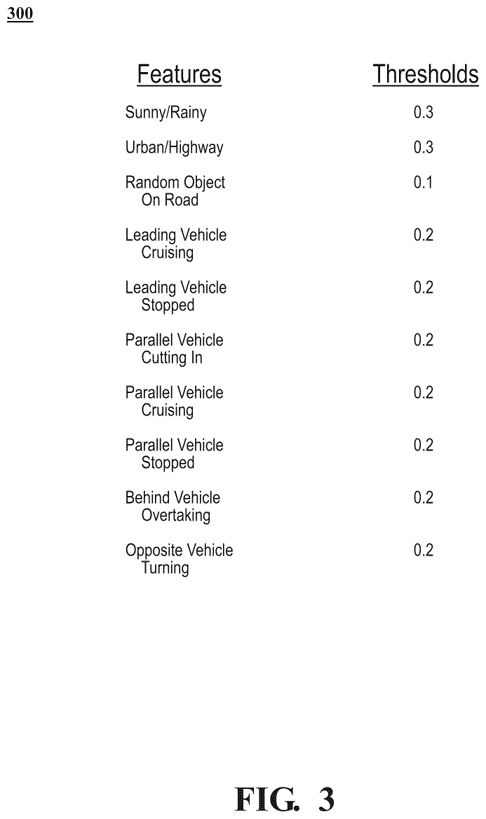

FIG. 3 includes a diagram that illustrates a table 300 of examples of features and thresholds, according to the disclosed technologies.

Additionally, for example, the feedback module 114 can further include instructions to produce the feedback. For example, the feedback can include information about a difference, with respect to a feature, between the first prospective recording and the real video (e.g., “The prospective video should include a leading vehicle stopped scenario.”).

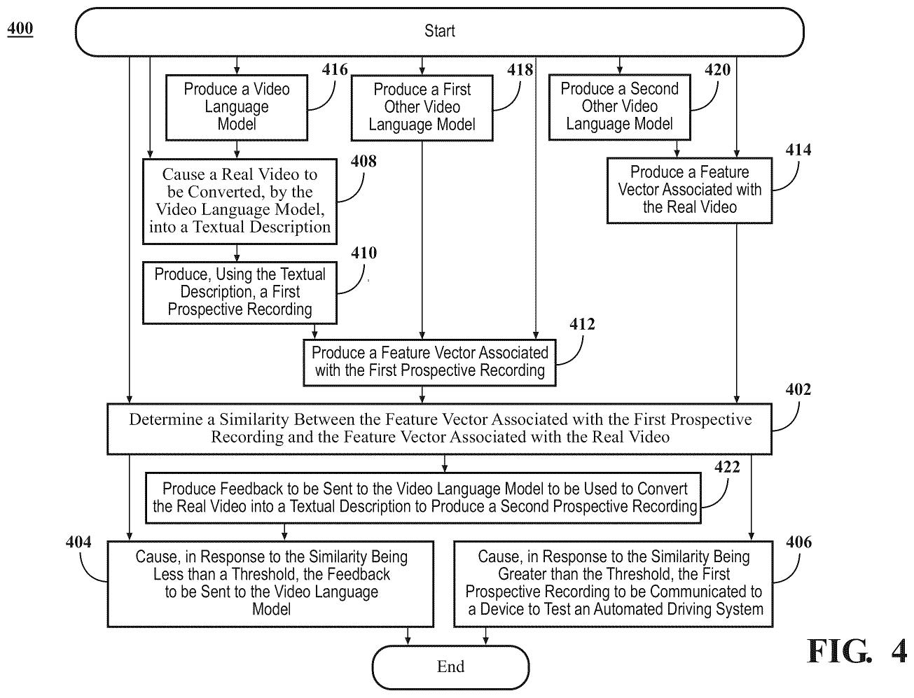

FIG. 4 includes a flow diagram that illustrates an example of a method 400 that is associated with producing a simulation recording to test an automated driving system, according to the disclosed technologies. Although the method 400 is described in combination with the system 102 illustrated in FIG. 1, one of skill in the art understands, in light of the description herein, that the method 400 is not limited to being implemented by the system 102 illustrated in FIG. 1. Rather, the system 102 illustrated in FIG. 1 is an example of a system that may be used to implement the method 400. Additionally, although the method 400 is illustrated as a generally serial process, various aspects of the method 400 may be able to be executed in parallel.

In the method 400, at an operation 402, for example, the comparison module 112 can determine a similarity between: (1) a feature vector associated with a first prospective video and (2) a feature vector associated with a real video.

At an operation 404, for example, the feedback module 114 can cause, in response to the similarity being less than a threshold, feedback to be sent to a video language model to be used to convert the real video into a textual description to produce a second prospective recording.

At an operation 406, for example, the communications module 116 can cause, in response to the similarity being greater than the threshold, the first prospective recording to be communicated, via the communications device 108, to the device 104 to test the automated driving system.

Additionally, at an operation 408, for example, the video language model module 118 can cause the real video to be converted, by the video language model, into a textual description to produce the first prospective recording. For example, the textual description to produce the first prospective recording can be prepared using a probabilistic programming language. For example, the probabilistic programming language can be associated with producing scenarios of an environment of a mobile robot (e.g., an automated vehicle) to test the mobile robot. For example, the probabilistic programming language can be SCENIC developed by the University of California, Berkeley.

Additionally, at an operation 410, for example, the simulation module 120 can produce, using the textual description, the first prospective recording. For example, the instructions to produce the first prospective recording can include instructions to produce, using an autonomous driving simulator, the first prospective recording. For example, the autonomous driving simulator can be CARLA developed by the Computer Vision Center at the Universitat Autonoma de Barcelona.

Additionally, at an operation 412, for example, the feature vector production module 122 can produce the feature vector associated with the first prospective recording. For example, at the operation 412, the feature vector production module 122 can produce, using a first other video language model, the feature vector associated with the first prospective recording.

Additionally, at an operation 414, for example, the feature vector module 122 can produce the feature vector associated with the real video. For example, at the operation 414, the feature vector production module 122 can produce, using a second other video language model, the feature vector associated with the real video.

For example, the second other video language model can be identical to the first other video language model.

For example, the video language model can include a multimodal generative pre-trained transformer. For example, the multimodal generative pre-trained transformer can include GPT-4o released in May 2024 by OpenAI, Inc. of San Francisco, California.

Additionally, at an operation 416, for example, the video language model production module 124 can produce the video language model. For example, at the operation 416, the video language model production module 124 can produce, using a prompt engineering process, the video language model. For example, a prompt engineering process can be a technique for designing inputs, or prompts, to guide an artificial intelligence (AI) model to generate a specific output. For example, the prompt engineering process can include: (1) preparing, using a probabilistic programming language, a set of training textual descriptions for driving scenarios, (2) producing, from the set of training textual descriptions and using an autonomous driving simulator, a set of training simulation videos, (3) defining a set of pairs, wherein a pair, of the set of pairs, comprises a training simulation video (of the set of training simulation videos) and a corresponding training textual description (of the set of training textual descriptions), and (4) training, using the set of pairs, a pre-prompt engineering version of the video language model to become the video language model. For example, the set of pairs can include twenty pairs. For example, the probabilistic programming language can be associated with producing scenarios of an environment of a mobile robot (e.g., an automated vehicle) to test the mobile robot. For example, the probabilistic programming language can be SCENIC developed by the University of California, Berkeley. For example, the autonomous driving simulator can be CARLA developed by the Computer Vision Center at the Universitat Autonoma de Barcelona. For example, the pre-prompt engineering version of the video language model can be capable of producing textual descriptions that include information about road layouts, traffic behavior, and environmental factors. For example, the set of training textual descriptions can include textual descriptions of a variety of driving scenarios: overtaking, cruising, sudden stops due to obstacles, turns in varying road conditions, and turns in varying weather conditions. For example, the video language model, produced using the prompt engineering process, can be capable of producing textual descriptions that include information about weather, traffic, road types, road conditions, vehicle dynamics, and vehicle behaviors.

One or more of the first other video language model or the second other video language model can include a multimodal generative pre-trained transformer. For example, the multimodal generative pre-trained transformer can include GPT-4o released in May 2024 by OpenAI, Inc. of San Francisco, California.

Additionally, at an operation 418, for example, the other video language model production module 126 can produce the first other video language model. For example, at the operation 418, the other video language model production module 126 can produce, using a prompt engineering process, the first other video language model. For example, a prompt engineering process can be a technique for designing inputs, or prompts, to guide an artificial intelligence (AI) model to generate a specific output. For example, the prompt engineering process can include: (1) predefining a set of feature categories, (2) preparing, using a probabilistic programming language, a set of training textual descriptions for driving scenarios, (3) defining a set of pairs in which a pair (of the set of pairs) can include a training textual description (of the set of training textual descriptions) and a corresponding feature vector (of a set of feature vectors), and (4) training, using the set of pairs, a pre-prompt engineering version of the first other video language model to become the first other video language model. For example, a first number can be a count of feature categories in the set of feature categories. For example, the first number can be ten. For example, a second number can be a count of training textual descriptions in the set of training textual descriptions. For example, the second number can be twenty. So, for example: (1) the second number can be a count of feature vectors of the set of feature vectors and (2) the first number can be a count of dimensions in the corresponding feature vector. For example, a dimension (of the dimensions) can be associated with a corresponding feature category (of the set of feature categories). For example, a value of the dimension can be one of a first value (e.g., one) or a second value (e.g., zero). For example, the first value can be indicative of a presence, in the training textual description, of a feature associated with the corresponding feature vector. For example, the second value can be indicative of an absence, in the training textual description, of the feature associated with the corresponding feature vector. For example, the probabilistic programming language can be associated with producing scenarios of an environment of a mobile robot (e.g., an automated vehicle) to test the mobile robot. For example, the probabilistic programming language can be SCENIC developed by the University of California, Berkeley.

Additionally, at an operation 420, for example, the other video language model production module 126 can produce the second other video language model. For example, at the operation 420, the other video language model production module 126 can produce, using a prompt engineering process, the second other video language model. For example, a prompt engineering process can be a technique for designing inputs, or prompts, to guide an artificial intelligence (AI) model to generate a specific output. For example, the prompt engineering process can include: (1) predefining a set of feature categories, (2) preparing, using a probabilistic programming language, a set of training textual descriptions for driving scenarios, (3) defining a set of pairs in which a pair (of the set of pairs) can include a training textual description (of the set of training textual descriptions) and a corresponding feature vector (of a set of feature vectors), and (4) training, using the set of pairs, a pre-prompt engineering version of the second other video language model to become the second other video language model. For example, a first number can be a count of feature categories in the set of feature categories. For example, the first number can be ten. For example, a second number can be a count of training textual descriptions in the set of training textual descriptions. For example, the second number can be twenty. So, for example: (1) the second number can be a count of feature vectors of the set of feature vectors and (2) the first number can be a count of dimensions in the corresponding feature vector. For example, a dimension (of the dimensions) can be associated with a corresponding feature category (of the set of feature categories). For example, a value of the dimension can be one of a first value (e.g., one) or a second value (e.g., zero). For example, the first value can be indicative of a presence, in the training textual description, of a feature associated with the corresponding feature vector. For example, the second value can be indicative of an absence, in the training textual description, of the feature associated with the corresponding feature vector. For example, the probabilistic programming language can be associated with producing scenarios of an environment of a mobile robot (e.g., an automated vehicle) to test the mobile robot. For example, the probabilistic programming language can be SCENIC developed by the University of California, Berkeley.

For example, the feature vector associated with the first prospective video can include: (1) information associated with a first feature in the first prospective recording and (2) information associated with a second feature in the first prospective recording. For example, the feature vector associated with the real video can include: (1) information associated with the first feature in the real video and (2) information associated with the second feature in the real video. For example, the similarity can include: (1) a first similarity between the information associated with the first feature in the first prospective recording and the information associated with in the real video and (2) a second similarity between the information associated with the second feature in the first prospective recording and the information associated with the second feature in the real video.

For example, at the operation 404, the feedback module 114 can cause, in response to the first similarity being less than the threshold or the second similarity being less than the threshold, the feedback to be sent to the video language model to be used to convert the real video into the textual description to produce the second prospective recording.

For example, at the operation 406, the communications module 116 can cause, in response to the first similarity being greater than the threshold and the second similarity being greater than the threshold, the first prospective recording to be communicated, via the communications device, to the device to test the automated driving system.

Additionally, for example, the threshold can include a first threshold and a second threshold.

For example, at the operation 404, the feedback module 114 can cause, in response to the first similarity being less than the first threshold or the second similarity being less than the second threshold, the feedback to be sent to the video language model to be used to convert the real video into the textual description to produce the second prospective recording.

For example, at the operation 406, the communications module 116 can cause, in response to the first similarity being greater than the first threshold and the second similarity being greater than the second threshold, the first prospective recording to be communicated, via the communications device, to the device to test the automated driving system.

Additionally, at an operation 422, for example, the feedback module 114 can produce the feedback. For example, the feedback can include information about a difference, with respect to a feature, between the first prospective recording and the real video (“The prospective video should include a leading vehicle stopped scenario.”).

Regarding automated driving systems, Standard J3016 202104, Taxonomy and Definitions for Terms Related to Driving Automation Systems for On-Road Motor Vehicles, issued by the Society of Automotive Engineers (SAE) International on Jan. 16, 2014, and most recently revised on Apr. 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-4, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user's computer, partly on a user's computer, as a stand-alone software package, partly on a user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor;
a communications device; and
a memory storing:
a comparison module including instructions that, when executed by the processor, cause the processor to determine a similarity between a feature vector associated with a first prospective recording and a feature vector associated with a real video;
a feedback module including instructions that, when executed by the processor, cause the processor to cause, in response to the similarity being less than a threshold, feedback to be sent to a video language model to be used to convert the real video into a textual description to produce a second prospective recording; and
a communications module including instructions that, when executed by the processor, cause the processor to cause, in response to the similarity being greater than the threshold, the first prospective recording to be communicated, via the communications device, to a device to test an automated driving system.

2. The system of claim 1, wherein the memory further stores a video language model production module including instructions that, when executed by the processor, cause the processor to produce the video language model.

3. The system of claim 2, wherein:
the instructions to produce the video language model include instructions to produce, using a prompt engineering process, the video language model, and
the prompt engineering process comprises:
preparing, using a probabilistic programming language, a set of training textual descriptions for driving scenarios,
producing, from the set of training textual descriptions and using an autonomous driving simulator, a set of training simulation recordings,
defining a set of pairs, wherein a pair, of the set of pairs, comprises a training simulation recording, of the set of training simulation recordings, and a corresponding training textual description of the set of training textual descriptions, and
training, using the set of pairs, a pre-prompt engineering version of the video language model to become the video language model.

4. The system of claim 1, wherein the memory further stores a video language model module including instructions that, when executed by the processor, cause the processor to cause the real video to be converted, by the video language model, into a textual description to produce the first prospective recording.

5. The system of claim 4, wherein the textual description to produce the first prospective recording is prepared using a probabilistic programming language.

6. The system of claim 4, wherein the memory further stores a simulation module including instructions that, when executed by the processor, cause the processor to produce, using the textual description, the first prospective recording.

7. The system of claim 6, wherein the instructions to produce the first prospective recording include instructions to produce, using an autonomous driving simulator, the first prospective recording.

8. The system of claim 1, wherein the memory further stores a feature vector production module including instructions that, when executed by the processor, cause the processor to:
produce the feature vector associated with the first prospective recording; and
produce the feature vector associated with the real video.

9. The system of claim 8, wherein:
the instructions to produce the feature vector associated with the first prospective recording include instructions to produce, using a first other video language model, the feature vector associated with the first prospective recording, and
the instructions to produce the feature vector associated with the real video include instructions to produce, using a second other video language model, the feature vector associated with the real video.

10. The system of claim 9, wherein the second other video language model is identical to the first other video language model.

11. The system of claim 9, wherein the memory further stores another video language production model module including instructions that, when executed by the processor, cause the processor to produce at least one of the first other video language model or the second other video language model.

12. The system of claim 11, wherein:
the instructions to produce the at least one of the first other video language model or the second other video language model include instructions to produce, using a prompt engineering process, the at least one of the first other video language model or the second other video language model, and
the prompt engineering process comprises:
predefining a set of feature categories, a first number being a count of feature categories in the set of feature categories,
preparing, using a probabilistic programming language, a set of training textual descriptions for driving scenarios, a second number being a count of training textual descriptions in the set of training textual descriptions,
defining a set of pairs, wherein a pair, of the set of pairs, comprises a training textual description, of the set of training textual descriptions, and a corresponding feature vector of a set of feature vectors, the second number being a count of feature vectors of the set of feature vectors, the first number being a count of dimensions in the corresponding feature vector, a dimension, of the dimensions, being associated with a corresponding feature category of the set of feature categories, a value of the dimension being one of a first value or a second value, the first value being indicative of a presence, in the training textual description, of a feature associated with the corresponding feature vector, the second value being indicative of an absence, in the training textual description, of the feature associated with the corresponding feature vector, and
training, using the set of pairs, at least one of a pre-prompt engineering version of the first other video language model or a pre-prompt engineering version of the second other video language model to become the at least one of the first other video language model or the second other video language model.

13. The system of claim 8, wherein:
the feature vector associated with the first prospective recording comprises:
information associated with a first feature in the first prospective recording, and
information associated with a second feature in the first prospective recording,
the feature vector associated with the real video comprises:
information associated with the first feature in the real video, and
information associated with the second feature in the real video, and
the similarity comprises:
a first similarity between the information associated with the first feature in the first prospective recording and the information associated with the first feature in the real video, and
a second similarity between the information associated with the second feature in the first prospective recording and the information associated with the second feature in the real video.

14. The system of claim 13, wherein:
the instructions to cause, in response to the similarity being less than the threshold, the feedback to be sent to the video language model to be used to convert the real video into the textual description to produce the second prospective recording include instructions to cause, in response to the first similarity being less than the threshold or the second similarity being less than the threshold, the feedback to be sent to the video language model to be used to convert the real video into the textual description to produce the second prospective recording, and
the instructions to cause, in response to the similarity being greater than the threshold, the first prospective recording to be communicated, via the communications device, to the device to test the automated driving system include instructions to cause, in response to the first similarity being greater than the threshold and the second similarity being greater than the threshold, the first prospective recording to be communicated, via the communications device, to the device to test the automated driving system.

15. The system of claim 13, wherein:
the threshold comprises a first threshold and a second threshold,
the instructions to cause, in response to the similarity being less than the threshold, the feedback to be sent to the video language model to be used to convert the real video into the textual description to produce the second prospective recording include instructions to cause, in response to the first similarity being less than the first threshold or the second similarity being less than the second threshold, the feedback to be sent to the video language model to be used to convert the real video into the textual description to produce the second prospective recording, and
the instructions to cause, in response to the similarity being greater than the threshold, the first prospective recording to be communicated, via the communications device, to the device to test the automated driving system include instructions to cause, in response to the first similarity being greater than the first threshold and the second similarity being greater than the second threshold, the first prospective recording to be communicated, via the communications device, to the device to test the automated driving system.

16. A method, comprising:
determining, by a processor, a similarity between a feature vector associated with a first prospective recording and a feature vector associated with a real video;
causing, by the processor and in response to the similarity being less than a threshold, feedback to be sent to a video language model to be used to convert the real video into a textual description to produce a second prospective recording; and
causing, by the processor and in response to the similarity being greater than the threshold, the first prospective recording to be communicated to a device to test an automated driving system.

17. The method of claim 16, further comprising producing, by the processor, the feedback.

18. The method of claim 17, wherein the feedback comprises information about a difference, with respect to a feature, between the first prospective recording and the real video.

19. The method of claim 16, wherein the real video comprises a video of a collision produced by a dashboard camera of a motorized vehicle that was involved in the collision.

20. A non-transitory computer-readable medium for producing a simulation recording to test an automated driving system, the non-transitory computer-readable medium including instructions that, when executed by one or more processors, cause the one or more processors to:
determine a similarity between a feature vector associated with a first prospective video and a feature vector associated with a real video;
cause, in response to the similarity being less than a threshold, feedback to be sent to a video language model to be used to convert the real video into a textual description to produce a second prospective recording; and
cause, in response to the similarity being greater than the threshold, the first prospective recording to be communicated to a device to test the automated driving system.
